(19) United States
(12) Patent Application Publication
(10) Pub. No.: US 2015/0295732 A1
(43) Pub. Date: Oct. 15, 2015

(54) ETHERNET POWERED DEVICE

(71) Applicant: WEN-HSIEN LAI, Taoyuan Hsien (TW)

(72) Inventor: WEN-HSIEN LAI, Taoyuan Hsien (TW)

(73) Assignee: IN WIN DEVELOPMENT, INC., Taoyuan Hsien (TW)

(21) Appl. No.: 14/248,911

(22) Filed: Apr. 9, 2014

(51) Int. Cl. H04L 25/02; H01R 24/64

(52) U.S. Cl. CPC H04L 25/026; H01R 24/64

(57) ABSTRACT

The present invention discloses an Ethernet powered device. A PoE splitter is added with an RJ45 connector which is connected synchronously with another non-PoE device through an Ethernet cable. Accordingly, the PoE splitter can transmit power to a non-PoE device, including a wireless AP, a CPE, a router, etc., through the Ethernet cable, and is also able to connect another non-PoE device, such as a monitor.

### BACKGROUND OF THE INVENTION

(a) Field of the Invention

The present invention relates to an Ethernet powered device, wherein a PoE (Power over Ethernet) splitter is added with an RJ45 connector to connect synchronously another non-PoE device, such as a monitor, through an Ethernet cable.

(b) Description of the Prior Art

It is known that PoE is a technology for transmitting power and data to a device through a twisted pair wire in the Ethernet. The device including an internet telephone, a wireless access point, a web camera, a hub, a computer, etc., can be supplied with power by the PoE technology. As the electronic equipment powered by the Ethernet can be used without requiring an additional power socket, the time and money spent in configuring the power cable can be saved, thereby reducing the cost of the entire device. In addition, as an RJ45 network socket is now used worldwide, all kinds of PoE equipment are compatible. This technology is often compared with the conventional POTS (Plain Old Telephone System) that power and data are received on a same cable. PoE can be operated without changing the cable structure of Ethernet. Therefore, while using a PoE system, the cost can be saved, the wiring can be done easily, and the capability for remote energizing and de-energizing is available. PoE is also divided into PSE (Power Sourcing Equipment) and a PD (Powered Device), i.e., a power supply terminal and a power intake terminal.

The IEEE standard 802.3af-2003 describes a machine of 15.4 W DC (the minimum specifications can be 44V DC and 350 mA). However, due to power loss in the twisted pair wire, the steady power can only reach 12.95 W. On the other hand, the modified PoE specification as described in the IEEE standard 802.3at-2009, or the PoE+ standard, can provide electric power of as high as 25.5 W to equipment. This 2009 standard does not allow the equipment to use all four wire pairs for providing power. Some vendors have already claimed that their products include those that are compatible with the 802.3at standard, wherein these products can implement high power of 51 W and provide power through one primary cable associated with all four sets of the secondary cables.

Nevertheless, the existing electronic equipment powered by the PoE technology can only provide power by a one-to-one method, not by a non-PoE to non-PoE or non-PoE to non-LAN method. In addition, the existing electronic equipment cannot be adapted to an AC device, either. Therefore, the prior art requires improvement.

### SUMMARY OF THE INVENTION

Accordingly, the primary object of the present invention is to provide an Ethernet powered device, wherein a PoE splitter is added with an RJ45 connector to connect synchronously another non-PoE device, such as a monitor, through an Ethernet cable.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a circuit block diagram according to a PoE device of the present invention.

FIG. 2 shows a flow block diagram according to a PoE injector and a PoE splitter of the present invention.

FIG. 3 shows another flow block diagram according to the PoE injector and the PoE splitter of the present invention.

FIG. 4 shows a schematic view according to the PoE splitter of the present invention.

### DETAILED DESCRIPTION OF THE PREFERRED EMBODIMENTS

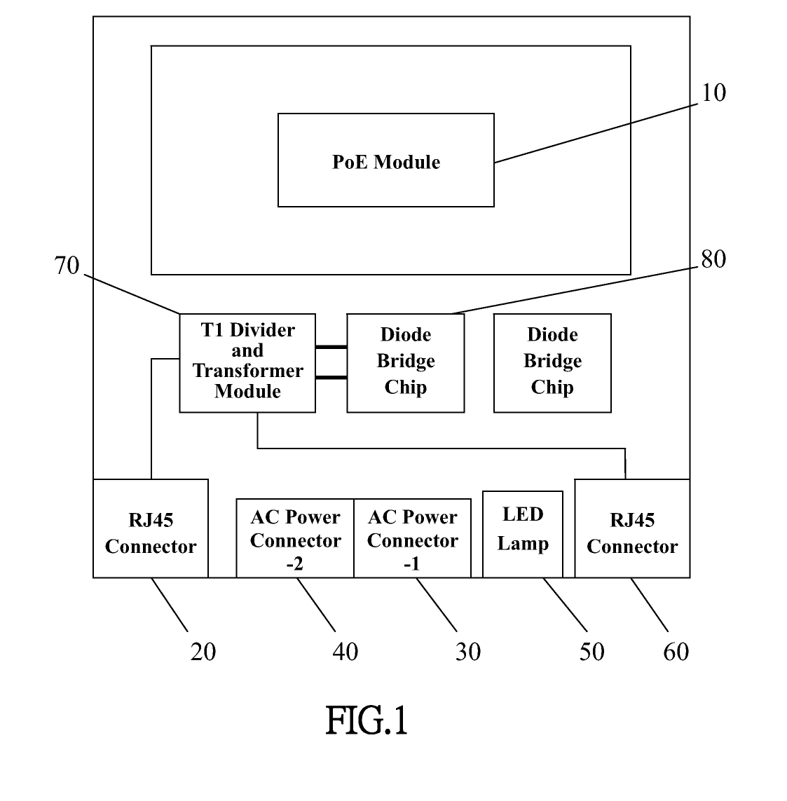

Referring to FIG. 1, it shows a PoE splitter of the present invention, wherein a PoE module 10 is coupled with an RJ45 connector 20, an AC power connector-1 30, an AC power connector-2 40, an LED lamp 50, another RJ45 connector 60, a T1 divider and transformer module 70 and a diode bridge chip 80. According to the Data Out of an Ethernet cable, the RJ45 connector 20 transmits power to the AC power connector-1 30 and the AC power connector-2 40 through plural wire pairs. In addition, under the powered state, the LED lamp 50 will illuminate. The RJ45 connector 60 transmits data and power through the Ethernet cable. The T1 divider and transformer module 70 is connected electrically with the RJ45 connectors 20, 60, and is coupled with the diode bridge chip 80.

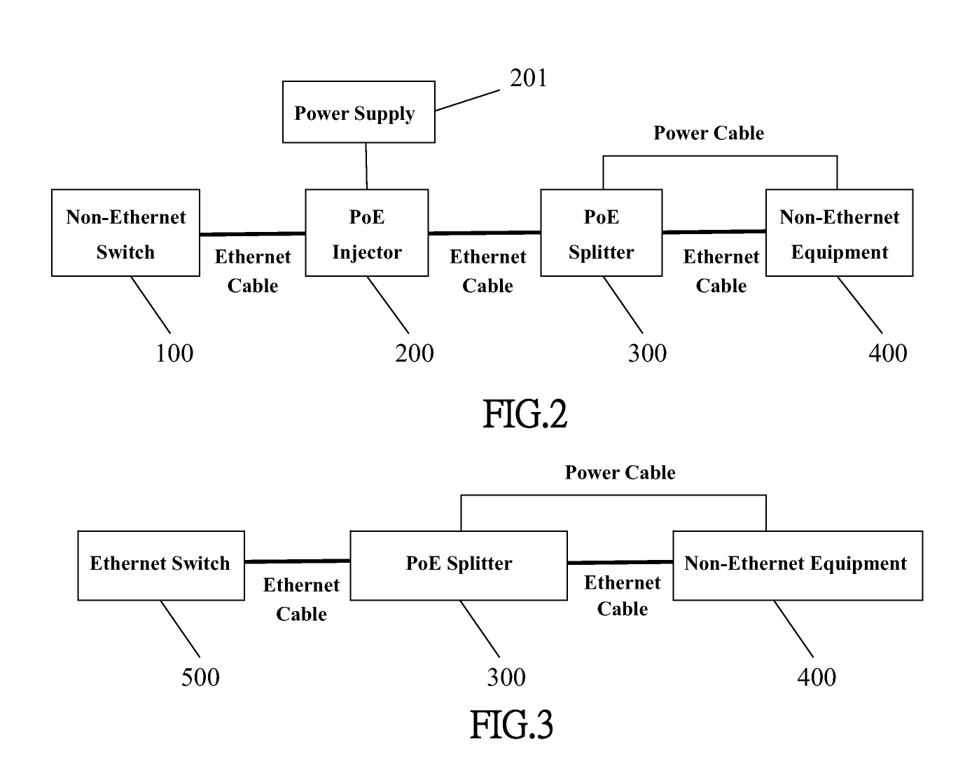

Referring to FIG. 2, a non-PoE network switch 100 of the present invention transmits power from a PoE injector 200 to a PoE splitter 300 through the Ethernet cable, supplies power to the PoE splitter 200 using a power supply 201, and then transmits power to a non-PoE device 400, including a wireless AP (Access Point), a CPE (Customer Premises Equipment), a router, etc., through the Ethernet cable.

Referring to FIG. 3, a PoE network switch 500 transmits power directly to the PoE splitter 300 through the Ethernet cable, skipping the PoE injector 200. The PoE network switch 500 then transmits power to the non-PoE device 400, including a wireless AP, a CPE, a router, etc., through the Ethernet cable.

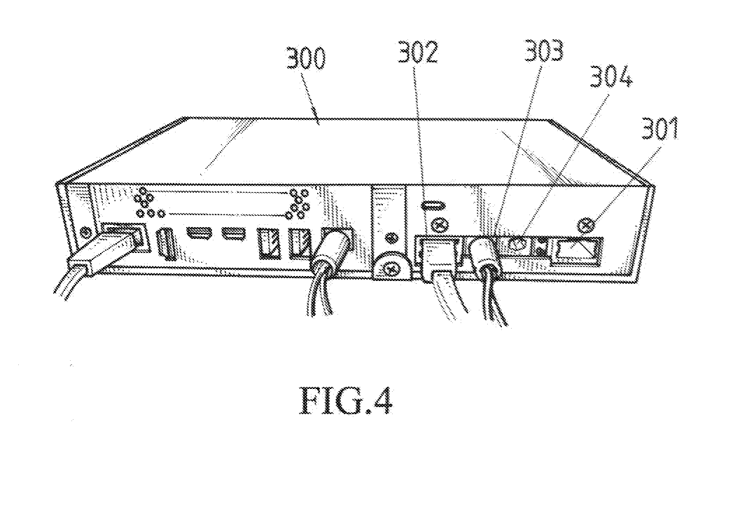

Referring to FIG. 4, it shows the PoE splitter 300 of the present invention. An RJ45 connector 301 is inserted with the Ethernet cable to connect a PoE switch, whereas another RJ45 connector 302 is inserted with the Ethernet cable to connect a non-PoE device. A power connector 303 is inserted with a power cable to connect a LAN (Local Area Network). The present invention is characterized in that the PoE splitter 300 is added with an RJ45 connector 304 which is connected synchronously to another non-PoE device (not shown in the drawings), such as a monitor, through the Ethernet cable.

In conclusion, according to the above description of the embodiments of the present invention, a PoE splitter is added with an RJ45 connector which is inserted with an Ethernet cable to connect another non-PoE device, such as a monitor.

It is to be understood that the above description and drawings are only used for illustrating some embodiments of the present invention, not intended to limit the scope thereof. Any variation and deviation from the above description and drawings should be included in the scope of the present invention.

What is claimed is:

1. An Ethernet powered device, wherein a PoE splitter is provided with at least one RJ45 connector and power connector, wherein one RJ45 connector is inserted with an Ethernet cable to connect a PoE switch, another RJ45 connector is inserted with the Ethernet cable to connect a non-PoE device, and the power connector is inserted with a power cable to connect a LAN, the present invention being characterized in that the PoE splitter is added with an RJ45 connector which is connected synchronously to another non-PoE device through the Ethernet cable.

2. The Ethernet powered device according to claim 1, wherein the PoE splitter includes a PoE module, and the PoE module is coupled with at least one RJ45 connector, AC power connector, an LED lamp, a T1divider and transformer module and a diode bridge chip, with that one RJ45 connector transmits data through the Ethernet cable, a PSE transmits power to an AC power connector of a PD through plural wire pairs, the LED lamp illuminates in a powered state, another RJ45 connector transmits data and power through the Ethernet cable, the T1 divider and transformer module is connected electrically with the two RJ connectors and is coupled with a diode bridge chip.
